(19) United States
(12) Patent Application Publication
(10) Pub. No.: US 2006/0098973 A1
(43) Pub. Date: May 11, 2006

(54) Universal exposure meter method for film and digital cameras

(76) Inventor: Patrick Verdier, Cumberland, RI (US)

Correspondence Address: BARLOW, JOSEPHS & HOLMES, LTD., 101 DYER STREET, 5TH FLOOR, PROVIDENCE, RI, 02903, US

(21) Appl. No.: 11/266,977

(22) Filed: Nov. 4, 2005

Related U.S. Application Data
(60) Provisional application No. 60/625,892, filed on Nov. 8, 2004.
(60) Provisional application No. 60/688,892, filed on Jun. 9, 2005.

(51) Int. Cl. G03B 17/18

(52) U.S. Cl. 396/291

(57) ABSTRACT

An exposure metering method wherein the scene to be photographed is imaged such that the absolute luminance values for all digitized pixels in the scene are recorded and displayed. A custom lookup table is applied that elucidates the f-stop relationship of all of the elements of the scene simultaneously. The imaged data is correlated directly to the characteristic response of a particular recording medium, by designating one or more key colors that relate key ranges of scene luminance values to key regions of the recording medium response. Using this approach, the entire scene is visualized directly from the perspective of the recording medium. An optimal exposure can be rapidly generated that takes into account the relationship between all luminance levels in the scene, regardless of lighting conditions, scene contrast, subject complexity, or the specific recording medium for which the exposure determination is intended.

### CROSS-REFERENCE TO RELATED APPLICATIONS

This application is related to and claims priority from earlier filed U.S. Provisional Patent Application Nos. 60/625,892, filed Nov. 8, 2004 and 60/688,892 filed Jun. 9, 2005, the contents of which are incorporated herein by reference.

### BACKGROUND OF THE INVENTION

The present invention relates generally to a new exposure meter device and a method of metering the proper exposure settings for use in film based or digital photography. More specifically, the present invention relates to a method and device for metering the light levels in a desired photographic scene using an imaging based light meter that codes the various levels of luminous intensity throughout the scene to provide a real time luminous intensity display to the photographer. Using such a system, all luminance values of a scene are visualized and measured instantly, while simultaneously relating all of these luminance values to the characteristic response of a particular recording medium.

In the field of photography light metering is accomplished either through interpretive metering, wherein the readings taken by a light meter are read by the photographer and interpreted to determine the correct exposure settings for the camera, or through non-interpretive (automatic) metering that are designed to bypass the measurement aspect of metering and set a camera exposure directly. In either case, the state of the art in light level metering generally includes two main types of exposure meter. The first type is the incident light meter, which measures the level of available ambient light that illuminates an overall scene. This type of lighting is described generally as illumination. The second type of meter is the reflected light meter, which measures the level of the light that is reflected from a scene. This lighting is generally referred to as scene luminance. One or both of these two basic types of meter are incorporated into a wide variety of exposure meter systems that utilize a variety of different sensor types and arrangements, as well as a variety of output modalities to display the results. Furthermore, as stated above, these systems can range from manual standalone systems to fully automatic systems that are incorporated directly into a camera.

Regardless of the type of metering system used, the purpose of an exposure meter is to interpret the incident (scene illumination) or reflected light (scene luminance) and to generate a reading in the form of a suggested exposure value (EV). This exposure value provides a photographer with a value that is a combination of lens aperture setting and the appropriate exposure time for a given speed of photographic medium.

Each of the above described art metering arrangements has attendant drawbacks however. The advantage of an incident light meter is that it measures the overall amount of light available (illumination) to the scene with a single reading, making this a useful metering system particularly when overexposure is to be avoided, such as when using slide film. However, there is little or no information provided by an incident light meter about the total contrast range between the particular elements of the scene, resulting in assumptions that have to be made regarding the level and distribution of actual scene luminance values. Similarly, while reflected light meters have the advantage of measuring the actual light levels coming from each of the various subjects within a scene directly to the camera, the number of actual metering points is limited thereby limiting the range of contrast within the scene that can actually be measured.

In an attempt to address variations in illumination across the scene of photographic interest and to account for scene contrast, multiple meter readings are generally taken in order to determine the range of overall scene contrast, or to place particular elements of the scene within specific regions of the of the photographic recording mediums response. For example, most automatic metering systems allow for user defined compensation factors to be applied in order to take into account extremes in scene luminance such as back lighting, filter factors, flash ratios, and other exposure related parameters. In addition, many systems have memory functions that permit exposure determination based on average or accumulated readings. While these types of functionalities extend the versatility of the metering system in question, there is required on the part of the end user a considerable degree of expertise and knowledge in order to implement them properly. In a similar fashion, when using a manual type meter, these sets of readings are usually taken using a spot meter, a spot meter being a specialized reflected light meter that measures a very small angular region of a scene, typically on the order of 1 degree or less. By using multiple spot meter readings, a final exposure value is determined based on key luminance values using a relatively limited sampling of the actual scene, the overall level of contrast in the scene, and the experience of the photographer.

Further, difficulties are encountered due to the assumptions that must be made because an incident light meter measures a different photon flux than a reflected meter. The incident light meter when calculating an EV must make an assumption that the scene will reflect a certain percentage of the available illuminating light. The reflected light meter, on the other hand, in order to generate the same EV, must assume that it is measuring the same percentage of reflected light flux as that assumed by the incident meter. Traditionally, the reflectance value has been assumed to be 18% for an average scene, and meters have generally been calibrated such that the 18% reflectance value would produce a middle gray tonal value that falls at the approximate mid point of the straight line portion of the characteristic performance curve of a photographic medium. Current metering systems generally use a lower value, typically between 12% and 16%, wherein the specific amount is determined by a ration of the calibration constants of the two systems.

In order to address these issues, there are in the existing art, a series of systems that attempt to simplify exposure determination by relating the dynamic range of the scene, directly to the dynamic range of the photographic recording medium response in a single step. Further, many of these systems attempt to accomplish this in a graphical manner.

While many of the prior art systems meter exposure by relating the general content of the scene to the response and range of a specific photographic recording medium, none of them do so in a manner that immediately and graphically provides the photographer with feedback related to the specific response of detailed scene elements as a result of the particular exposure or the interrelationship between the various elements of the scene.

There is therefore a need for a light meter that is designed to combine the advantages of both metering systems while eliminating the attendant disadvantages. There is a further need for a meter wherein a single reading is made that reveals the entire range of luminance values across all parts of the scene and relates these values directly to the sensitivity of the recording medium, thereby providing the photographer the ability to quickly set any region to any value at his discretion. There is still a further need for a metering system wherein all of the elements of the scene are metered directly against the response of a given photographic medium, while simultaneously taking into account all of the relationships within the scene, such as key subject luminance values, scene contrast, f-stop relationships, evenness of illumination, flash levels, and other pertinent exposure related parameters.

### BRIEF SUMMARY OF THE INVENTION

In accordance with the present invention an exposure/light metering method is provided that combines the advantages of both the incident and reflectance metering systems and provides a single reading that reveals the luminance values of each of the elements in the scene to be photographed. The method of the present invention is applicable for evaluating scene luminance and determining the optimal exposure value for virtually any type of photographic medium. Further, the method of the present invention is imaging based, and as such, permits the photographer to visualize and evaluate all of the scene luminance values simultaneously in a dynamic and interactive manner. Using this approach provides readings regarding the absolute luminance of each physical element in the scene, the relative luminance (contrast) between each of the elements of the scene, and the effect of the ambient lighting distribution (evenness) across the entire scene, simultaneously. In this manner, the method of the present invention permits rapid determination of optimal exposure regardless of ambient or artificial illumination conditions, background luminance, subject complexity, subject type or subject size relative to the field of view.

In operation, the method of the present invention provides for imaging a scene in a manner whereby the imaged data consists of a record of the absolute luminance values for all digitized pixels in the scene. A custom lookup table is then applied to the imaged data to group the digitized pixels based on their relative luminance values and assign a display value to each group in a manner that elucidates the f-stop relationship of all elements of the scene simultaneously. Using this approach, the photographer has immediate knowledge of all luminous intensities in the scene, their f-stop relationship, the total dynamic range of the scene, evenness of illumination, keys subject luminance values and other important exposure related parameters

The imaged data is then related directly to the characteristic response of the recording medium. To accomplish this, one or more key colors are designated to relate key ranges of scene luminance directly to key regions of the photographic recording medium's response. Using this approach, exposure is visualized directly from the perspective of the recording medium, allowing the photographer to see and adjust the exposure based on the characteristic response of a particular recording medium.

It is important to note that the method of the present invention, unlike conventional metering systems, provides for the entire scene to be metered and visualized as a whole. In this manner, multiple metering functions, each corresponding to an individual pixel within the scene, take place simultaneously. In addition, because the metering system is dynamic, that is it is constantly recalculating the meter values of the scene, it enables precise and interactive evaluation of changing exposure values as camera settings are adjusted, as filters are being applied or adjusted, as lighting conditions change or as artificial lighting is adjusted. Further, because imaging data obtained by the meter can be stored, unlimited metering combinations can be derived and visualized from a single reading or from the combination of several readings. This is particularly useful in scenes where multiple sources of illumination are used or where the dynamic range of the scene exceeds the dynamic range of the meter.

A metering device that operates in accordance with the method of the present invention is suitable for incorporation directly into existing camera or for use as a standalone system. In the case where the metering device is incorporated into an existing camera, the system will provide a visual display that is dynamically updated to directly reflect any camera adjustments, such as changes of aperture, exposure time, flash level, as well as the effect of any applied filter. In the case where the metering system is independent of the recording system, the response of the meter is preferably made to approximate, through filtration or mathematical derivation the response of the recording medium with which it is being used.

Accordingly, it is an object of the present invention to provide a method of metering a photographic scene that samples the entire visual field of the scene and provides luminance information regarding every object within the scene. It is a further object of the present invention to provide a method of metering a photographic scene whereby the data collected by the meter consists of a recording of the absolute luminance values for all digitized pixels in the scene. It is still a further object of the present invention to provide a method of metering a photographic scene whereby the digitized pixels collected by the meter are displayed using a lookup table to group them based on their relative luminance values and assign a display value to each group in a manner that elucidates the f-stop relationship of all elements of the scene simultaneously. It is yet another object of the present invention to provide a photographic metering system that includes a visual display that dynamically updates to directly reflect any exposure value adjustment applied to the scene, such as changes of aperture, exposure time, flash level, as well as the effect of any applied filter.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a schematic diagram indicating the operation of the method of the present invention and depicting the general relationship between meter sensitivity, EV setting, lookup table, and recording medium response;

FIG. 2 shows lookup table variations for application to the imaged data;

FIG. 3 is an illustration of the method of the present invention as applied to a scene with a narrow field of exposure;

FIG. 4 is an illustration of the method of the present invention including an array of bracketed exposures;

FIG. 5 is an illustration of the method of the present invention with the image separated into zones by the metering operation;

FIG. 6 is an illustration of the method of the present invention for use in low-resolution applications;

FIG. 7 is an illustration of a look-up table that is formed based on the performance curve of the photographic medium;

FIG. 8 is an illustration of the method of the present invention used in conjunction with filters;

FIG. 9 shows the dynamic response of the metering system of the present invention as scene adjustments are made; and

FIG. 10 is histogram and lookup table showing the relationship of the raw imaged and processed image data after applying a reciprocity transfer function.

### DETAILED DESCRIPTION OF THE INVENTION

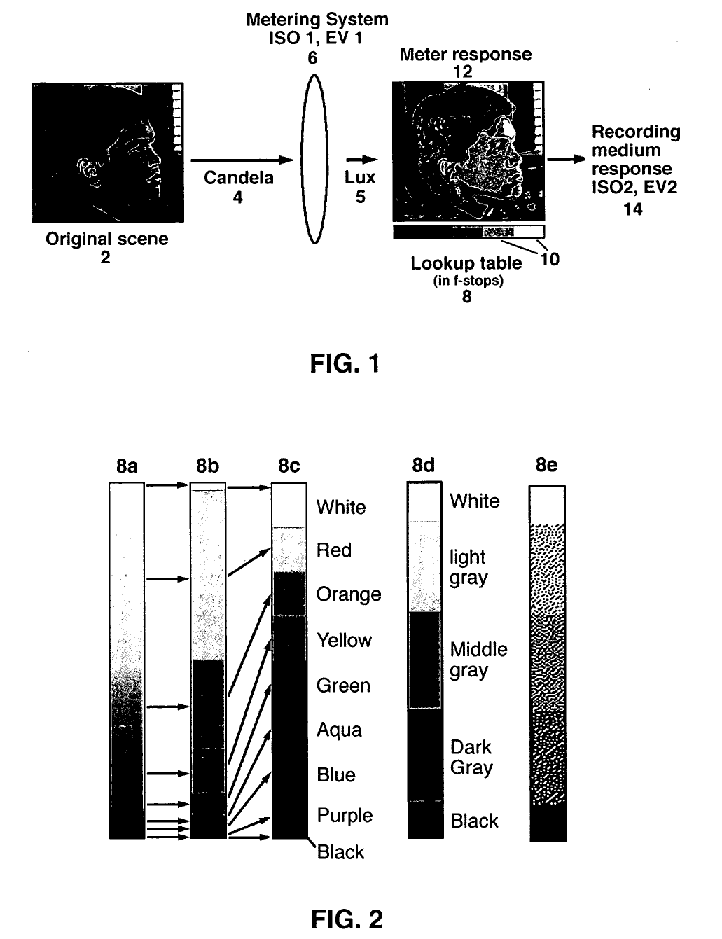

Now referring to the drawings, the universal exposure metering method of the present invention is illustrated schematically at FIG. 1. The metering method of the present invention is particularly adapted for metering the illumination levels in a scene to be photographed 2. Such luminance levels 4 are typically metered in candelas as indicated in the figure. The method then provides for capturing an image 6 of the photographic scene 2 wherein the captured image consists of an array of pixels. The metering system then using the luminance levels, records the Lux values 5 generated at the sensor plane for each of the pixels within the array of pixels comprising the captured image. Next, a predefined lookup table 8, is applied to generate a display image 12 that depicts the response of the metering system. The lookup table 8 includes a limited number of discrete sub-ranges 10 that each represents a contiguous grouping of a predetermined number of luminance values. Further each of the discrete sub-ranges 10 within the lookup table 8 has a coded value, such as a unique color or grayscale intensity, such that the coded value correlated directly to a discrete sub-range of scene luminance values. Preferably, each sub-range corresponds to a discrete f-stop range of scene luminance value and fractions or multiples thereof.

In applying the lookup table 8, a display value is assigned to each of the pixels wherein the display value corresponds to the sub-range 10 within which the luminance value 4 of each of said pixels falls. Finally, a display image 12 that depicts the response of the metering method is produced wherein each pixel in the array pixels is displayed using said assigned display values. In this manner, it can be seen that the metering method of the present invention provides a dynamic metering display response that allows a user identify the dynamic and contrast range of the entire scene in a single glance as well as providing a quick visual reference that quickly identifies the relative tonal values of every subject of interest within the photographic scene.

It should be noted that for every point source (pixel) of the scene, the luminous flux at the sensor plane in Lux-seconds, will correspond to the original candela value divided by 2EV of the meter setting. The angular coverage of each imaging pixel is related to the physical dimensions of the pixel, and the focal length of the lens being used in the system. Because the metering system has a known sensitivity (effective ISO speed), the response for any other ISO photographic medium 14 will be proportional to the ISO ratio of the two systems. More specifically, the EV difference will be equal to the base 2 log of the ISO ratios (EV2=EV1−LOG2 ISO1/ISO2).

With regard to the apparatus suitable for the present invention, for the purposes of construction, any imaging device can be used that has well defined sensitivity, spectral response and gain characteristics. While monochrome sensors have the advantage of greater spectral range and sensitivity, color sensors have the advantage of built in spectral discrimination. Further, the bit depth of the system determines the total dynamic range that can be recorded in a single reading, and the precision with which lower light values are measured.

It should also be appreciated that within the scope of the present invention the preferred embodiment method can be implemented either in a stand alone exposure meter such as any type of device known in the art or as a metering system incorporated into any form of photographic device such as a film based or digital camera. In such arrangements, the devices will include at least a means for capturing an image of a photographic scene as an array of pixels, means for recording a luminance value corresponding to each of the pixels in the array of pixels, means for applying a defined a luminance range to said array of pixels as described above to assign a display value to each the pixels and a display for generating a metered display image wherein each pixel is displayed using its assigned display values. In any case, the preferred means for capturing an image of a photographic scene is a digital imaging device such as a CCD, CMOS or any other suitable digital imaging device known in the art. Similarly, the preferred means for recording a luminance value and applying a defined luminance range to the array of pixels is a computer processor device including storage memory and a display wherein the luminance range is applied and displayed by said computer processor using one of a plurality of look-up table stored in said storage memory.

A device utilizing the metering method of the present invention may also include means for adjusting exposure values utilized in capturing the image of the photographic scene. Such exposure adjustment may be effected physically as is well known in the art through adjustments in shutter speed and aperture settings. Similarly, the adjustments may be done electronically to compensate for the sensitivity of the photographic media being used. Further, adjustments in exposure value may be reflected in the final image based in a mathematical transformation of one or more original images, in order to best reflect the response of a particular photographic medium being used. In any case, the method of the present invention provides for the dynamic metering arrangement to respond to such adjustments or changes in exposure value by immediately generating an adjusted metered display image that reflects the effects that result from the adjusted exposure values.

A device implementing the method of the present invention may be calibrated with a calibrated light source, or against another calibrated exposure meter. The simplest calibration involves imaging an appropriate source, and measuring the response against the EV (aperture and exposure time) setting of the meter. For a particular sensor, the speed point of the system can be defined as the exposure that produces the first useable response, usually as determined by the specific gain and offset applied to the imaging system. The effective ISO of the metering is based on the formula 2^{EV}/Cd=ISO. (for example, an ISO 100 system will produce the first useable response with a scene luminance of 0.01 Cd at EV=0) In an ideal linear system, each doubling of digital value corresponds to a 1 f-stop increase in scene luminance, and 1 f-stop of additional response in both the metering and recording systems.

Referring now to FIG. 2, a variety of defined luminance ranges 8 are presented in the form of look up tables. As was stated, the lookup tables may be represented by gradient shades of gray of in distinct colors for added visual discrimination. The lookup tables are applied to the metered data to elucidate the exposure relationships within a scene using a variety of color schemes. In the case of linear data, a defined range of the systems output is may be re-mapped from 0 to 255 for the purpose of displaying on a standard 8-bit display. An exponential lookup table can be applied in either continuous mode 8a, or ramp mode 8b. The look-up table is designed with one or more key colors or shades to best elucidate the f-stop relationships within the scene, as well as key scene values. Alternatively, the raw data can undergo an initial base 2 log transfer function, in which case it is directly translated and visualized in f-stop increments. When this data is re-mapped from 0 to 255, each f-stop increment will contain the same number of gray levels, a lookup table depicting such a relationship is indicated at 8c. Further a lookup table may also be generated using limited number of gray levels to simply indicate relative exposure of items at middle gray, in highlight, in shadow or that are over exposed or under exposed such as the lookup table at 8d. Further for low resolution or binary display devices the lookup table will utilize display values that are dithered or halftoned as illustrated at 8e. Additional variations include blinking of specific ranges in the lookup table to highlight key scene luminance ranges such as speed point, mid point, or end point for a particular photographic recording medium.

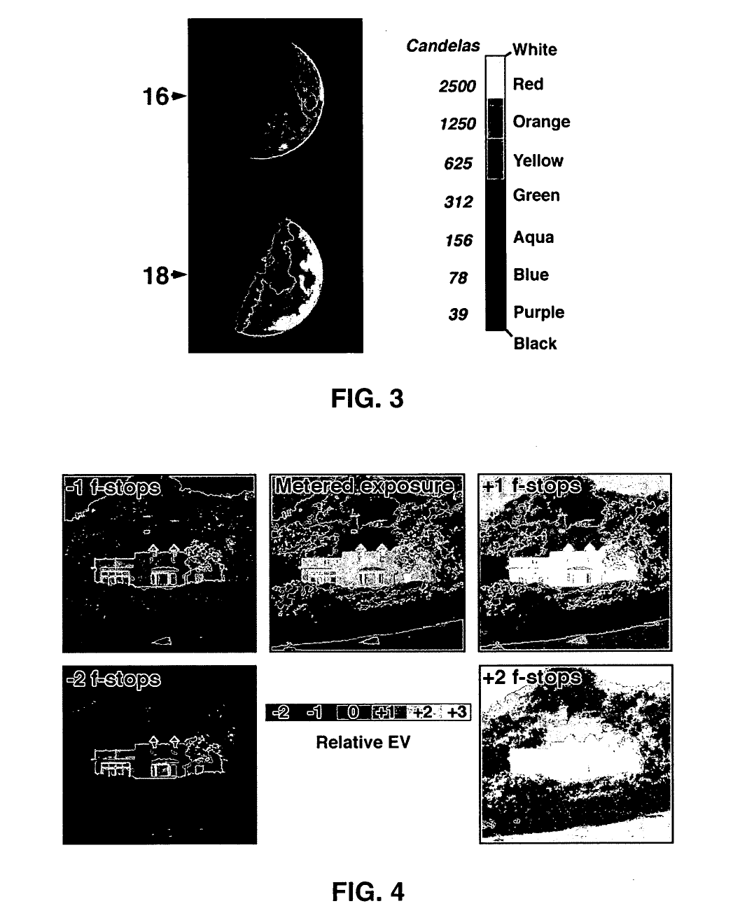

FIG. 3 provides a dynamic illustration of the benefits associated with the method of the present invention wherein the luminance value of each pixel is recorded. When metering any subject using the method of the present invention, each pixel within the captured image becomes an individual spot meter, and as such, even small subjects can contain hundreds if not thousands of distinct luminance values. This extended resolution is particularly important where it is necessary to rapidly meter a small subject against a simple or complex background. The absolute luminance value for every imaged pixel is recorded, and an appropriate lookup table is applied. The moon is used in this illustration where the original scene 16 is depicted above and the metered image 18 is shown below. Because the small angular coverage of the subject (½ degree) it is difficult to obtain accurate metering measurements with conventional systems. In this example, the metered image of the moon 18, shows 5 distinct zones (f-stops) of dynamic range while a conventional meter would be lucky to provide a single spot meter reading. Given this broad range of newly available metering information that is produced by the method of the present invention, an appropriate exposure can be determined by using any of the methods described in the remainder of this document.

Referring to FIG. 4, an illustration is provided in order to illustrate the dynamic operation of the present invention. As can be seen in the image depicting the metered exposure 20, the meter is adjusted such that the desired “middle gray” portion of the scene falls within a specific key color indicated at “0” in the lookup table 22. It can be sent that in addition to identifying the middle gray regions of the scene, the metered exposure 20 also simultaneously provides visualization of the f-stop relationships of all other elements of the scene in the metered exposure 20. Middle gray is set to a specific key color, while the other colors represent the departure from middle gray (−2, −1, +1, +2 etc.) in f-stops, zones, or EV values. In dynamic operation, as the exposure value used to capture the scene is changed, by −1 f-stop at 24, −2 f-stops at 26, +1 f-stop at 28 and +2 f-stops at 30, it can be seen that in response to the changes, every element in the scene shifts by exactly one key color for every incremental f-stop change. By changing the meter EV value in fractional f-stop increments, the transition between key colors becomes extremely apparent, which in turn permits extremely precise placement of any given scene element in any desired exposure range. A final exposure is based on the sensitivity difference (effective speed) of the meter vs. the photographic medium, and the desired calibration (K value) of “middle gray”.

Alternately, rather that setting the first key color to the desired “middle gray value, the first key color may be set to the speed point of the metering system. The exposure for any other medium is related to the ISO speed ratios of the two systems. For example, if the metering system has an ISO value of 400, an exposure for ISO 100 media would be 2 EV values less (2 f-stops additional exposure) than the meter EV value. The aperture and exposure time combinations for the final EV value can be set to aperture or shutter priority as in any other metering system. Alternatively, the actual exposure time (or aperture) of the meter can be altered from the actual setting based on the desired output ISO. For example, a 1/100 sec exposure can be set to 1/400 sec to emulate the 2 EV response difference between ISO 400 and ISO 100. In this manner, the metering system can “see” a scene from the perspective of any recording medium in a manner that is transparent to the user. Additionally, it is possible to slightly shift the entire lookup table to reflect fractional f-stop changes in ISO levels or exposure time.

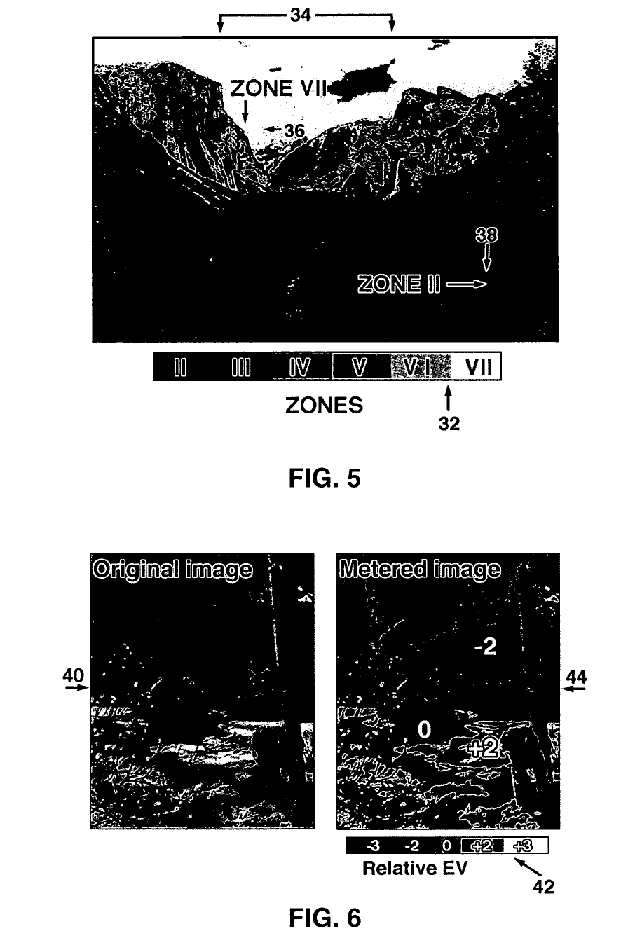

Referring to FIG. 5, in a variation of the above embodiment, the metering system implements a zone system of exposure. The lookup table is shifted so that the speed point of the medium is at zone I, and “middle gray” is at zone V (calibration constant K of 16). The lookup table 32 is then constructed to show any zone range, depending on the dynamic range of the scene 34 or the desired placement of a particular subject 36, 38 within a particular zone. This method can be used in combination with the high dynamic range method listed below.

Referring to FIG. 6, in a case where the bit depth of the meter's display is limited, the imaged data 40 can be visualized with a simplified lookup table 42. In this specific example, 5 gray levels are used in the lookup table 42. The metered data 44 shows no values below −2, and only very small areas above +2. In this example, because limited gray levels are available as a result of the limited display response, the central key color comprises a full f-stop of dynamic range, and the flanking colors each comprise 2 f-stops of dynamic range. Alternatively, key color ranges (middle gray, speed point, end point etc.) can be elucidated by blinking the appropriate imaging data.

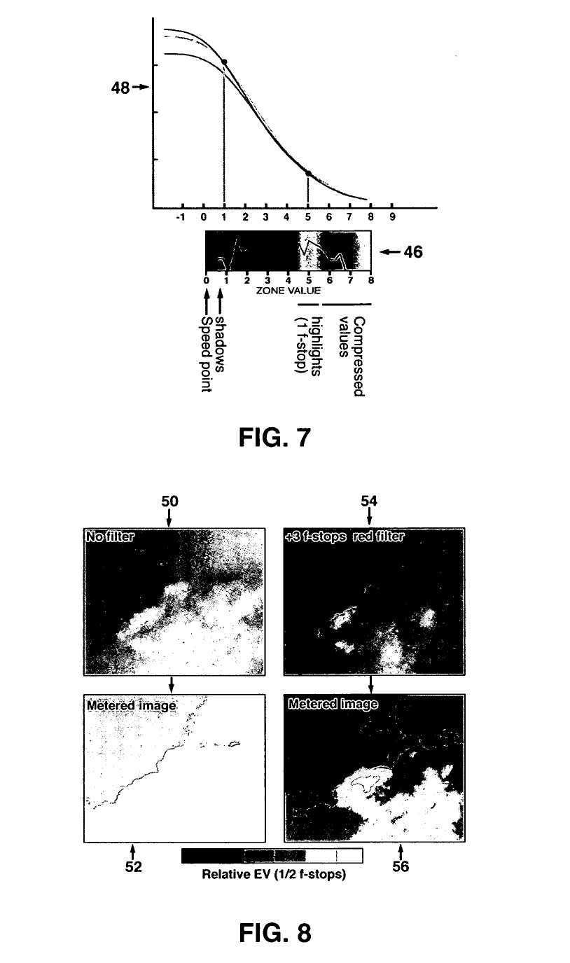

Turning now to FIG. 7, an example is illustrated wherein the photographic scene is being metered directly against the specific response of the desired photographic medium, in this case Ektachrome 100 (curve modified from Kodak corporation). The lookup table 46 applied to the image is plotted based on the image histogram 48 that depicts the characteristic response of the recording medium. This particular lookup table 46 is designed to identify the useful range of the film. In this case, the transition from black marks the onset of the curve showing good separation of values, while the light gray region marks the upper full f-stop range where there is still full separation of values. Black and white regions indicate areas of compressed or saturated values. For digital media, the first key color can be set to a desired minimum signal to noise ratio, and the upper key colors set based on the location of the antiblooming shoulder for the particular digital sensor. Note also that his type of lookup table 46 can be dynamically adjusted to “slide” the key colors up and down to match the response of a specific medium. In the preferred version of this embodiment, a color lookup table would replace the grayscale lookup table described above for greater differentiation in the key regions.

It is also a frequent problem to balance ambient with artificial illumination. For example, it is often necessary to determine the base exposure from the ambient lighting, and adjust the fill illumination sources to an appropriate level. It suffices to take a single reading for each condition to extrapolate any combination of fill lighting. Consistent with the design of the meter, all luminance level combination can be visualized for every element in the scene for every combination. The fill only luminance value is derived by subtracting the ambient image from the fill image after correcting for background and linearity. The fill image is then added or subtracted to the ambient image in a dynamic manner, until a suitable distribution of values is attained, these values in turn, being based on the distribution of key colors present in the applied lookup table.

In another variation of the above, all sources of illumination may be under user control, such as under studio conditions where multiple flood or flash illuminantion systems may be used. For each light source, a single reading is made, from which all possible subject luminance combinations are derived. This process permits innumerable precise metering combinations from a single composite reading, and thus reduces the need for multiple trial and error exposures, regardless of the media being used. In addition, because all elements of the scene are recorded, unintended illumination effects such as hot spots become readily apparent both qualitatively and quantitatively.

Referring now to FIG. 8, the metering system of the present invention will dynamically reflect the effect of any filter as they are being applied or adjusted (in the case of polarizers). In this case when preparing to photograph the image 50 the metered result can be seen at 52. Subsequently, a red filter (#25) was applied along with the 3 f-stop compensation factor, producing an image 54 and the metered result at 56. Note the expected increase in contrast by at least one stop in metered image 56, and the overall reduction in values despite the 3 f-stop compensation factor. This type of metering is useful for measuring actual as opposed to the theoretical filter factors in a rapid and dynamic manner while once again visualizing the entire range of exposure relationships in the scene.

A derivative of the metering system of the present invention is that any spectral range can be metered as long as the spectral response of the meter approximates the spectral response of the recording medium, and the relative sensitivity (ISO equivalent) of the meter and media are known. A color sensor can be used to measure RGB relationships or to emulate the spectral response of a particular photographic medium by applying weighted averages to the individual channels. Alternatively, a monochrome sensor without infrared blocking filter can be used to generate an infrared response. All aspects of the metering process remain the same including determining the absolute and relative intensities of the scene, the total dynamic range, and the distribution of luminous intensities within the scene.

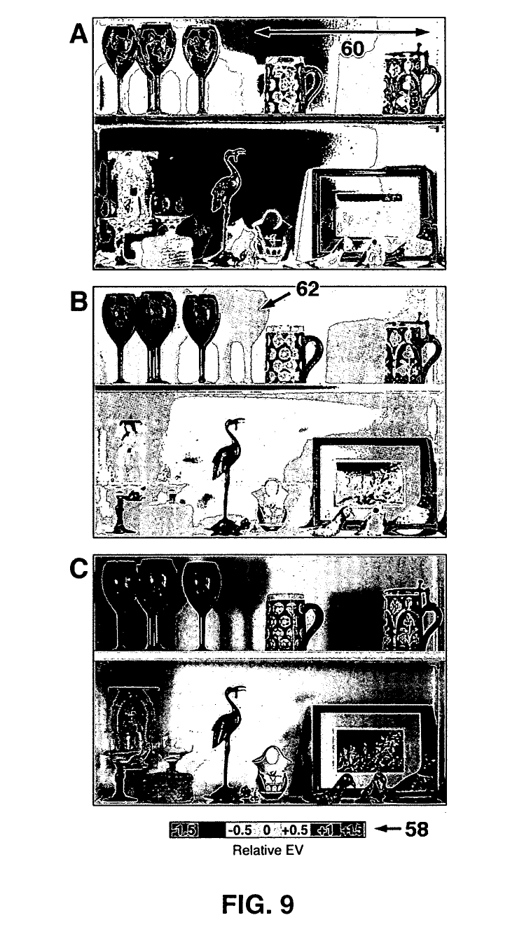

Referring to FIG. 9, a benefit that is associated with the metering system of the present invention is that it permits evaluation the evenness of scene illumination concurrently with determining exposure. In this example, the lookup table 58 consists of solid colors in ½ f-stop increments for added precision. Image A shows 4½ stop levels of uneven illumination across the area indicated by the long arrow 60. After adjusting the basic exposure and the left illumination source, image B shows a more even scene illumination. This type of metering is useful to dynamically adjust scene illumination levels, and also reveals important scene details such a shadows, indicated in image B at the arrow 62, and their exact f-stop intensity relationship with all other elements of the scene.

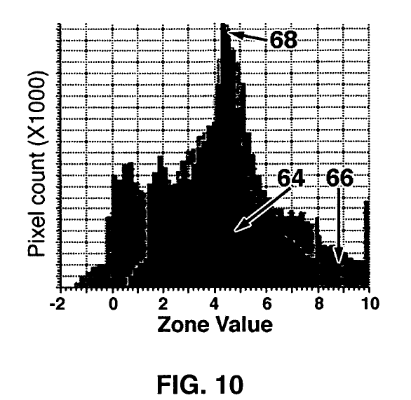

Referring to FIG. 10, once a scene is acquired, it is possible to alter the raw data to reflect the response of a particular recording medium under specific conditions. In this example a low light, moderate contrast scene was acquired and is represented by the histogram in black indicated at 64. Next, a reciprocity factor of 2 f-stops was applied around a specific metered value. The effect is an overall increase in contrast represented by the light gray histogram at 66 where the metered key value 68 remains the same while the upper and lower values expand by an amount that is specific to the particular recording medium. This technique can be applied to visualize such parameters as reciprocity, expansion and contraction for traditional chemistry based media, or more generally to apply any media specific transfer function to recorded data to reflect the response of a particular medium to a given exposure.

If the dynamic range of the scene exceeds the dynamic range of the meter, multiple images at different exposures can be combined through known art, to form single high dynamic range images (usually following a base 2 log transform), and an appropriate lookup table can be applied to show the exposure related relationships within the scene. This type of metering can be used for measuring not only extremely bright subjects and dark backgrounds simultaneously, but also to increase the precision of measurement in the low value areas. This is based on the fact that digital images contain very few gray levels in the first bits. In an ideal linear system, the number of gray levels increases by 2 raised to the power of the f-stop increase, and as a result of this, the last full f-stop of linear range contains the same number of gray levels as all of the lower f-stops combined. Using the above method, metering the lower light levels in a scene can be accomplished with a high degree of precision due to the increase number of gray levels collected.

It can therefore be seen that the present invention provides a novel and dynamic light metering system that provides immediate and visual feedback to the user in a manner that assists in identifying the overall contrast and dynamic range in a photographic scene. Further, the present invention provides a metering method that is highly accurate across the entire field of the photographic scene due to the use of every pixel in the image as an individual spot meter. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A method for metering the luminance levels in a photographic scene comprising:
capturing an image of said photographic scene, said image formed from an array of pixels;
recording a luminance value corresponding to each of said pixels in said array of pixels;
defining a luminance range measured between an upper and lower recorded luminance value;
defining a lookup table, said lookup table having a limited number of discrete sub-ranges, wherein each sub-range represents a contiguous grouping of a predetermined number of luminance values within said luminance range, wherein each sub-range represents one of a plurality of corresponding display values;
assigning a display value to each of said pixels corresponding to the sub-range within which the luminance value of each of said pixels falls; and
generating a metered display image wherein each pixel in said array of pixels is displayed using said assigned display values.

2. The method of claim 1, wherein each of said sub-ranges is selected from the group consisting of: incremental f-stop values within said luminance range, fractions of f-stop values within said luminance range and multiples of f-stop values within said luminance range.

3. The method of claim 1, wherein said sub-ranges are determined by the characteristic response of the photographic medium being used, wherein each of said sub-ranges corresponds to a defined sub-range of said characteristic response.

4. The method of claim 1, wherein said step of capturing an image further comprises:
capturing a plurality of images;
combining said plurality of images to form a composite image, wherein said composite image contains a sum of scene luminance values to be recorded in said photographic scene.

5. The method of claim 1, further comprising:
adjusting exposure values utilized in capturing said image of said photographic scene; and
generating an adjusted metered display image based on said adjusted exposure values.

6. The method of claim 5, wherein said adjusted exposure value is determined based on the range and distribution of scene luminance values in the photographic scene.

7. The method of claim 6, wherein said adjusted exposure value is determined based on the characteristic response of the photographic medium.

8. An exposure meter comprising:
means for capturing an image of a photographic scene, said image formed from an array of pixels;
means for recording a luminance value corresponding to each of said pixels in said array of pixels;
means for applying a defined a luminance range to said array of pixels, said luminance range having a limited number of discrete sub-ranges, wherein each sub-range represents a contiguous grouping of a predetermined number of luminance values, wherein each sub-range represents one of a plurality of corresponding display values, wherein a display value is assigned to each of said pixels corresponding to the sub-range within which the luminance value of each of said pixels falls; and
a display for generating a metered display image wherein each pixel in said array of pixels is displayed using said assigned display values.

9. The exposure meter of claim 8, wherein said means for capturing an image of a photographic scene is a digital imaging device.

10. The exposure meter of claim 8, wherein said means for recording a luminance value is a computer processor device including storage memory and said means for applying a defined a luminance range to said array of pixels is accomplished by said computer processor using one of a plurality of look-up tables stored in said storage memory.

11. The exposure meter of claim 8, further comprising:
adjusting exposure values utilized in capturing said image of said photographic scene; and
generating an adjusted metered display image based on said adjusted exposure values.

12. The exposure meter of claim 11, wherein said adjusted exposure value is determined based on the range and distribution of luminance values in the photographic scene.

13. The exposure meter of claim 11, wherein said adjusted exposure value is determined based on the characteristic response of the photographic medium.

14. A photographic apparatus including an integrated exposure meter comprising:
a camera for capturing an image of a photographic scene;
means for digitizing said image to form a digitized image comprising an array of pixels;
means for recording a luminance value corresponding to each of said pixels in said array of pixels;
means for applying a defined a luminance range to said array of pixels, said luminance range having a limited number of discrete sub-ranges, wherein each sub-range represents a contiguous grouping of a predetermined number of luminance values, wherein each sub-range represents one of a plurality of corresponding display values, wherein a display value is assigned to each of said pixels corresponding to the sub-range within which the luminance value of each of said pixels falls; and
a display for generating a metered display image wherein each pixel in said array of pixels is displayed using said assigned display values.

15. The photographic apparatus of claim 14, wherein said means for capturing an image of a photographic scene is a digital imaging device.

16. The photographic apparatus of claim 14, wherein said means for recording a luminance value is a computer processor device including storage memory and means for displaying a defined luminance range from said array of pixels by said computer processor by using one of a plurality of look-up tables stored in said storage memory.

17. The photographic apparatus of claim 14, further comprising:
adjusting exposure values utilized in capturing said image of said photographic scene; and
generating an adjusted metered display image based on said adjusted exposure values.

18. The photographic apparatus of claim 17, wherein said adjusted exposure value is determined based on the range and distribution of luminance values in the photographic scene.

19. The photographic apparatus of claim 17, wherein said adjusted exposure value is determined based on the characteristic response of the photographic medium.
